(19) United States
(12) Patent Application Publication
(10) Pub. No.: US 2024/0391295 A1
(43) Pub. Date: Nov. 28, 2024

(54) ENHANCED DOUBLE-EFFECT ABSORPTION SYSTEM UTILIZING A LOW VOLTAGE SOURCE IN ORDER TO LIMIT DRAINING OF AN EV TYPE BATTERY IN COMBINATION WITH AN HVAC ASSEMBLY FOR HEATING AND COOLING OF THE BATTERY

(71) Applicant: Martinrea International US Inc., Auburns Hills, MI (US)

(72) Inventors: Murali Chandrasekhar, Rochester Hills, MI (US); Cory Doble, Ortonville, MI (US); Larry Harris, Otisville, MI (US)

(21) Appl. No.: 18/665,739

(22) Filed: May 16, 2024

Related U.S. Application Data
(60) Provisional application No. 63/468,055, filed on May 22, 2023.

(51) Int. Cl. B60H 1/22; B60K 11/02; B60L 1/02; B60L 58/20; H01M 10/613; H01M 10/625; H01M 10/6569; H01M 10/663

(52) U.S. Cl. CPC B60H 1/2215; B60K 11/02; B60L 1/02; B60L 58/20; H01M 10/613; H01M 10/625; H01M 10/6569; H01M 10/663; H01M 2220/20

(57) ABSTRACT

A system for minimizing higher voltage battery drain loss resulting from extreme environmental temperatures outside of an optimal operating range of an EV Battery. The HVAC assembly includes inputs for heating and cooling of the higher voltage battery using induction heat applied to an enhanced double-effect absorption process powered from a lower voltage auxiliary battery to limit draining of electrical power from the higher voltage battery.

### CROSS REFERENCE TO RELATED APPLICATIONS

The present application claims the priority of U.S. Ser. No. 63/468,055 filed May 22, 2023.

### FIELD OF THE INVENTION

The present invention relates generally to EV battery technology and is likewise applicable to any application that requires a thermal management system to control the environment at proper temperatures. More specifically, the present invention teaches an HVAC assisted assembly for minimizing battery drain loss, such as resulting from extreme environmental temperatures outside of the optimal operating range of the battery. The present invention provides an alternative process for thermal management of the EV systems to extend the driving range of the vehicle and can replace or assist the high voltage air conditioning compressor used in most EV thermal systems. The HVAC assist system includes inputs for heating the battery, through induction, as well as cooling, indirectly using an enhanced double-effect absorption system using a low voltage IE control battery to limit draining/power loss of the EV drive power from the higher voltage drivetrain batteries so as to extend driving range and thereby maintaining the thermal management requirements for the control circuit auxiliary battery. The HVAC (Heating, Ventilation and Air Conditioning) system can heat and cool the passenger cabin and/or the higher voltage drive train battery indirectly from the enhanced double-effect absorption process using induction energy from the auxiliary lower voltage battery. Other features include combining the enhanced HVAC design with the battery pack's system of cooling and heating, as well as providing auxiliary heating/cooling of the vehicle passenger compartment to further ameliorate power loss from the EV batteries.

### BACKGROUND OF THE INVENTION

Developments in battery technology are ongoing for optimizing performance for such as electrical vehicle (EV) applications. As is known, on average, existing EV batteries lose 15% of their power in generating heat due to the chemical reactions to produce electric power, which can be captured in the glycol fluid from the EV heat pump loop and returned to the chiller and used for the passenger cabin or as needed heat or the absorption process.

Additionally, conventional Heat-pumps and PTC (Positive Temperature Coefficient) heaters rely on the higher voltage battery for thermal control of the vehicle, resulting in a reduction of the battery power level and driving range.

As is also known, heating and cooling of the passenger cabin results in draining of EV battery power. In both cases, there is a significant loss of range due to heating and cooling, resulting from draining of the battery's power. Additionally, known electric vehicle current heat-pump designs significantly drain the battery's energy such that, when the system is turned on, losses of at least 2% of the battery's power occurs depending on voltage. Furthermore, it is also known that a car's passenger cabin often requires at least twenty minutes to warm up in cold weather when conditioned by power flowing from the EV batteries.

Other known examples from the prior patent art include Sunderland U.S. Pat. No. 9,944,150, which teaches an HVAC system for an EV vehicle having an electric motor powered by at least one battery and having a blower, a conduit configured to carry air from the blower to vents leading to a passenger cabin of the EV, and an electric heater positioned in the conduit and configured to heat the air. The HVAC system may further includes a thermal reservoir heater positioned in the conduit and including a thermal storage component configured to heat the air without using power from the battery.

Sutherland, US 2018/0154735, teaches another HVAC system for an EV vehicle which includes an electric motor powered by at least one battery. A blower and conduit is configured to carry air to vents leading to a passenger cabin of the EV, with an electric heater positioned in the conduit and configured to heat the air. A thermal reservoir heater is positioned in the conduit and includes a thermal storage component configured to heat the air without using power from the battery.

KR102013991 teaches a secondary battery supply for an EV vehicle and more specifically the techniques for charging the auxiliary battery. KR1020040045937 teaches thermal management techniques for an EV battery including a combination of a battery tray having a cooling pan and an air inlet hole. A thermos-element is adhered to both faces of each battery module stored in a battery tray. A temperature sensor is adhered to the each module to sensor the temperature in real time, with a battery management system (BMS) sensing the temperature of each battery module to control it and a power control unit connected with the thermos-element to control the supply and cutting of electricity and the BMS to allow a signal to be communicated.

Manam US 2019/0381861 teaches a heat pump assembly for heating air within the passenger cabin of an EV vehicle for increasing driving range, such as in cold weather conditions. Liu U.S. Pat. Nos. 9,517,703 and 9,517,705 both present a feedback optimization system for an EV vehicle for optimizing driving range, with Sumi US 2022/0048400 teaching another type of EV management system directed to managing a fleet of EV type vehicles.

Gautheir U.S. Pat. No. 11,021,073 teaches another version of an EV power management system which maintains power to the various vehicle “always-on” components and subsystems during periods of vehicle non-use, and without requiring the low voltage battery to undergo frequent charge/discharge cycling. The system uses a secondary DC/DC converter that has a lower output voltage and operates at a higher efficiency then the primary DC/DC converter in order to prolong the life of the battery via increased power consumption efficiency, thereby minimizing range loss while the car is parked.

Johnston U.S. Pat. No. 9,758,011 teaches an EV multi-mode thermal management system that allows efficient thermal communication between a refrigerant-based thermal control loop and three non-refrigerant-based thermal control loops. The refrigerant-based control loop may be operated either in a heating mode or a cooling mode and is coupled to the vehicle's HVAC system using a refrigerant air heat exchanger, and to the battery thermal control loop using refrigerant-fluid heat exchangers.

Finally, Hartmann U.S. Pat. No. 11,072,224 teaches an auxiliary heating system for motor vehicles driven by electric motors and a method for realizing an auxiliary heating function in a motor vehicle having an electric drivetrain.

### SUMMARY OF THE INVENTION

The present invention provides an HVAC assembly for EV vehicles which includes both of heating and cooling techniques for ensuring a suitable environment for passengers no matter what the weather conditions are. The HVAC assist system includes inputs for heating the battery, indirectly using an enhanced double effect absorption system using a lower voltage source IE control battery, as well as cooling, through an enhanced double-effect absorption, using a low voltage auxiliary source to limit the draining of the EV drive power source from the higher voltage drivetrain batteries, thereby keeping the thermal management requirements for the control circuit auxiliary battery. The HVAC system can heat and cool the passenger cabin and/or the high voltage drivetrain battery from the enhanced double-absorption process using induction energy from the auxiliary low voltage battery. Other features include combining the enhanced HVAC design with the battery pack's system of heating and cooling, as well as providing auxiliary heating/cooling of the vehicle passenger compartment to further ameliorate power loss from the EV batteries.

The absorption system functions on the principle that heat can be used to produce cold. Aqua ammonia, a mixture of hydrogen and ammonia and Ionic water, is used as the cooling agent because ammonia and water have a strong affinity for one another and because hydrogen has the ability to accelerate evaporation.

It is also possible to use several refrigerants, along with the addition of ejectors or pumps, such including any of R134a-DMAC, R1234 (yf & ze)-DMAC, R152a-DMAC, R600-DMAC, R124-DMAC, R744, and LiBr—H₂O, as well as adding nanoparticles to improve performance.

As the heat source, the system uses an induction device by a low-voltage source which generates a magnetic field in order to provide high-thermal energy for the operation of a heat generator. Additionally, aluminum oxide Al₂O₃ nanoparticles, insulating the generator and bubble pump, allow the mixture to heat up more quickly, remain at a constant temperature, and take less time to warm up.

Noteworthy, the manifold separator's crucial role as a trap expedites hydrogen separation from a mixture of hydrogen/ammonia vapour and a weak solution which passes the vent tube up to the configuration of the robust solution of ionic aqua-ammonia without heat loss.

As part of the present invention, a novel system is provided having a low voltage auxiliary power source to prevent power draining of the high voltage battery which would otherwise reduce vehicle drive range and to maintain proper thermal levels in each of the battery and the passenger cabin of the vehicle The present invention further aims to provide an HVAC system for EVs that combines two systems, along with either of direct heating/cooling of a cabin and battery pack. Furthermore, in the winter, warming up the cabin takes less time.

### BRIEF DESCRIPTION OF THE DRAWINGS

Reference will now be made to the attached drawings, when read in combination with the following detailed description, wherein like reference numerals refer to like parts throughout the several views, and in which:

FIG. 1a illustrates an HVAC assisted EV system according to a non-limiting embodiment of the present invention;

FIG. 1b is a similar illustration to FIG. 1a of the present invention of the HVAC components according to all of the embodiments;

FIG. 2 provides a further illustration similar to FIGS. 1a and 1b of the HVAC assisted EV system and their situation flow according to the present invention;

FIG. 3 illustrates an enlarged sectional view of an induction device which forms a portion of an EV heating feature according to the present invention; and

FIG. 4 illustrates an enlarged sectional view of a manifold separator and heating/cooling system for the battery pack, according to the present invention.

### DETAILED DESCRIPTION OF THE PREFERRED EMBODIMENTS

With reference to the attached illustrations, the present invention discloses an HVAC system for providing targeted heating and cooling of an EV battery pack as well as maintaining the desired thermal requirements of the passenger cabin. Regarding the attached illustrations, the present invention discloses an HVAC system for providing targeted heating and cooling of an EV passenger cabin. As previously described, the present invention provides an HVAC-assisted assembly for minimizing EV battery drain loss, and which assists the existing EV Thermal management system to prevent or limit the higher voltage battery loss from the operation of the air conditioning higher voltage compressor, such as resulting from extreme environmental temperatures outside the optimal operating range of the battery, and while providing for the comfort of the EV occupant.

As will be further described, the HVAC assist system includes inputs for heating the higher voltage battery as well as cooling, this accomplished through an enhanced double-effect absorption, using a lower voltage auxiliary source for limiting draining of the electrical power of the EVs' higher voltage batteries. Other features include combining the enhanced HVAC design with the battery pack's system of cooling and heating, as well as providing auxiliary heating/cooling of the vehicle passenger compartment to further ameliorate power loss from the EV batteries.

The EV HVAC thermal system operates on the principle of using heat to produce cold and to expel heat to the surrounding environment, which is reversible if it is desired to heat the battery or the passenger cabin. The absorption system uses a mixture of refrigerants as the cooling agent. At the same time, the solution (ionic water or DMAC solution) works to keep rising temperatures in the mixture, with hydrogen accelerating the evaporation process

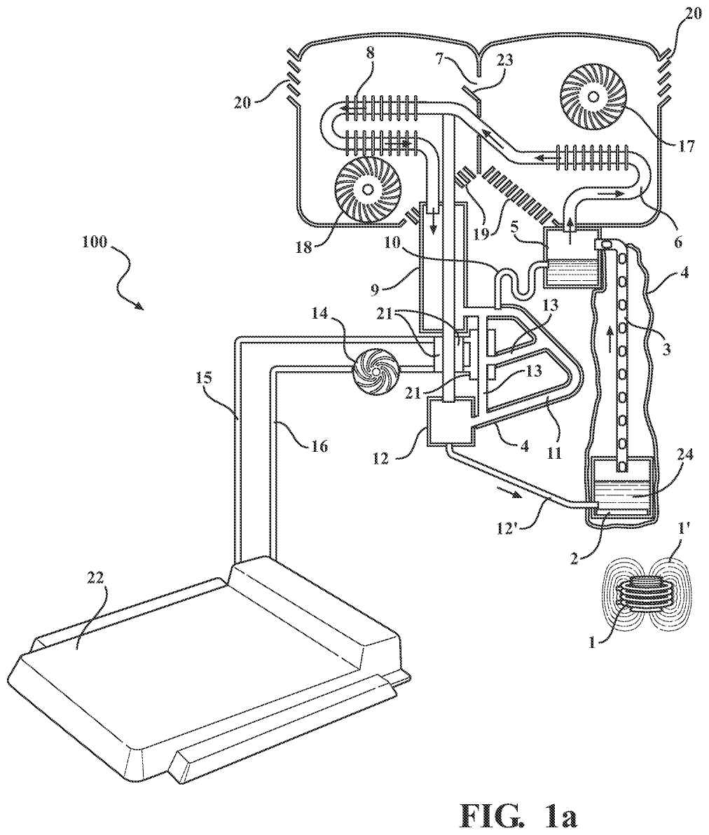

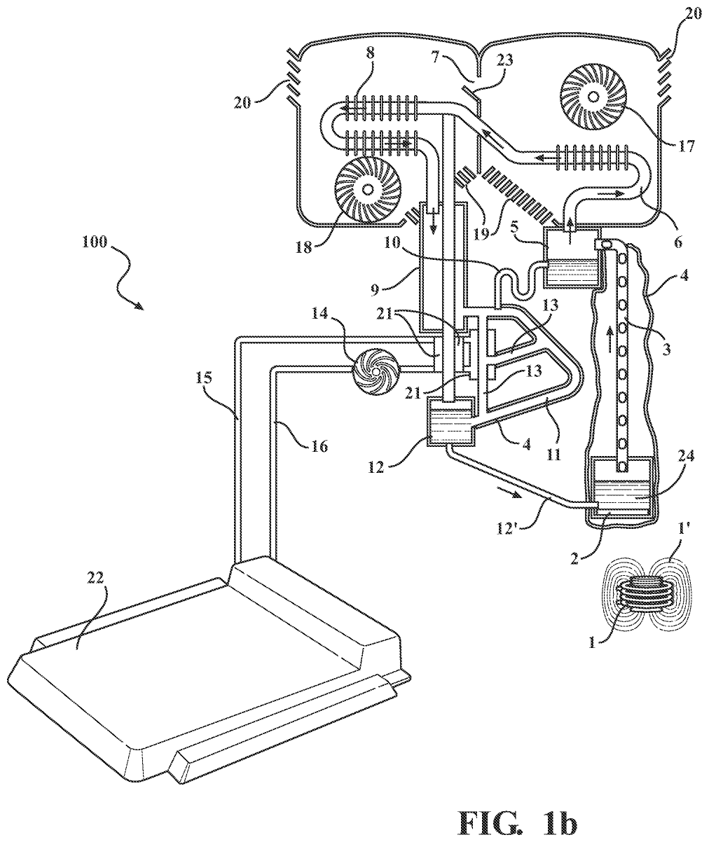

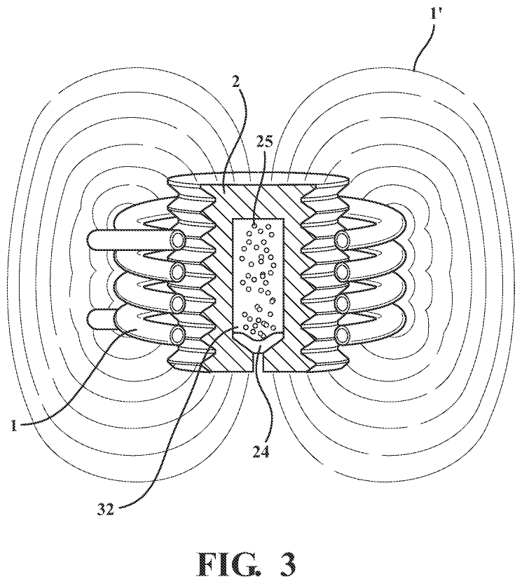

Given the above, and with reference now to each of FIGS. 1a and 1b, an HVAC system according to a non-limiting embodiment of the present invention is representatively shown at 100 and includes an induction device 1, which is depicted as generating a magnetic field 1′ around a heat generator 2. For purposes of ease of presentation, the induction device 1 is shown in FIGS. 1a and 1b separated from the heat generator 2, with an integrated view of the device and generator further being provided in FIG. 3.

The closed loop arrangement depicted includes each of a bubble pump 3 (such including internal bumps to intercept and partially capture the water vapour) insulated by a thermal insulation layer 4, a rectifier 5, condenser 6, throttle valve 7, evaporator 8, heat exchanger 9, vent tube 10, absorber 11, tank 12 with feedback line 12′, and manifold separator 13.

The cooling system for use with an EV battery pack also includes each of a solution low voltage pump 14, a double heat exchanger 21, and each of inlet 15 and outlet 16 tubes extending to and from a battery pack 22 (also defined as a higher voltage drivetrain battery). A ventilation system (such as associated with a passenger cabin or interior compartment of the vehicle) includes a pair of blowers 17 and 18, a ventilation inlet 19, and air drainage inlets/outlets 20, which are controlled by a valve in order to drain air inside or to be withdrawn outside of the vehicle (not shown).

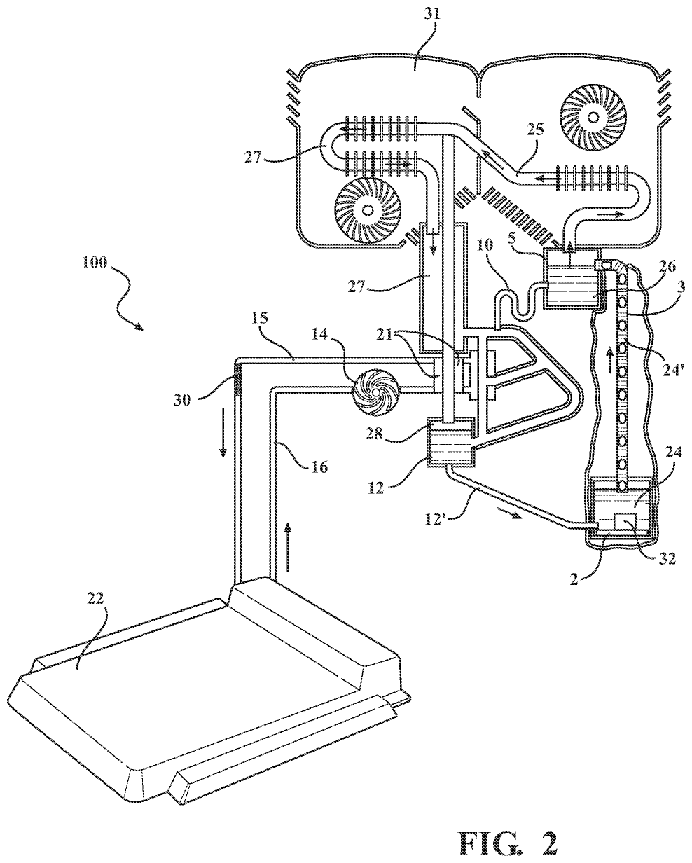

FIG. 2 provides a similar illustration as FIGS. 1a and 1b, with flow fluids depicted through the system, including their situation and direction. In accordance with the cooling aspect of the invention, an ionic aqua-ammonia solution 24 is positioned in the heat generator 2 during heating up the heat generator, with the solution evaporating and causing rising of the ammonia and water vapour 24′. In the rectifier 5, the ammonia and water vapour of the solution 24′ are separated into each of a light ammonia vapour 25, with the aqua-ammonia solution as a weak solution 26. Following the ammonia vapour 25 passing through the condenser 6 and throttle valve 7, cooling capacity increases by combining with a hydrogen vapour 28 that rises from the tank 12 to become a hydrogen/ammonia gases mixture 27, with a robust solution of an aqua-ammonia 29 produced by absorbing the ammonia into the weak solution accumulated in the tank 12 and communicated through the feedback line 12′ to the heat generator. In contrast, the hydrogen vapour 28 rises to the evaporator 8.

As described collectively in FIGS. 1, 2, &3), the operation of the system is as follows; the ammonia and ionic water solution or mixture 24 are heated up in the thermally insulated generator 2 by applying an electric-magnetic induction to the device 1 having a low voltage 1. At this point, the liquid 24′ starts to boil off, exits the aluminum oxide particles Al2O3 and then passes through the thermally insulated small tube (bubble pump) 3 to enter the rectifier 5 which assists in separating it into ammonia vapour 25 (see again as best shown in FIG. 3), because the ammonia vaporizes faster than water leaving a weak aqua-ammonia solution 26.

The ionic water preparation results from blending aluminium oxide (Al2O3) nanoparticles with distilled water by 0.1-50% by volume. Without limitation, other nanoparticles can be used to produce the ionic liquid that is utilized in the solution as long as there are no adverse reactions with the refrigerant and the mixture provides ideal thermodynamic properties.

As generally defined, a nanoparticle or ultrafine particle is usually defined as a particle of matter that is between 1 and 100 nanometres (nm) in diameter. By definition, a listing of nanoparticles can include any of carbon-based, ceramic, metal, semiconductor, polymeric and lipid-based nanoparticles.

For purpose of the present description, nanoparticles may include any of Aluminum Oxide (Al2O3), carbon nanotubes, along with Graphene derivatives, which are further defined to include without limitation any of a Graphene, monolayer Graphene, few layered Graphene, Graphene oxide, reduced Graphene oxide, and functionalized Graphene. Further, and while a combination of ALO3 and Graphene are desirable, it is understood that other combinations can be substituted without limitation.

Condensation of the ammonia vapour occurs in the condenser 6, leading to expelling heat to surrounding air, which can be withdrawn by the blower 17 outside the system or into the cabin, with the hot aqua solution recirculating to the absorber 11 through the vent tube 10 or use it to warm up the battery pack by adding a heat exchanger and pump.

The lighter ammonia vapour 25 rises from the condenser 6 and changes back to a liquid, then expand through the throttle valve 7 to drain into the evaporator 8, which mixes with the hydrogen vapour 28, which rises from the absorber and passing both the double heat exchanger 21 and double heat exchanger to configure the hydrogen/ammonia gases mixture 27. The gaseous mixture of ammonia vapour and hydrogen 27, heavier than either gas alone, passes into the absorber 11 and the manifold separator 13, where it meets water coming from the rectifier 5 via the vent tube 10. As the water absorbs the ammonia vapour to configure the robust aqua-ammonia solution 29, which returns to the heat generator after accumulating in the tank 12, the hydrogen returns to the evaporator once it has absorbed all the ammonia it can hold.

As described again with reference to the integrated illustration of the induction device 1 surrounding the heat generator in FIG. 3, the principle of the induction device 1 depends on applying the electromagnetic induction field 1′ around the heat generator body 2, which in turn is manufactured from such as a low-carbon steel (or other suitable conductive material), such that the magnetocaloric effect of the introduced field increases heat generation of the body 2 of the heat generator and then converts the heat to the ammonia and ionic water mixture fluid solution 24, this occurring at location 32 (see again FIG. 2). As is further known, the induction process is performed by the device 1 utilizing a separate or auxiliary voltage range of twelve to forty eight volts in order to adapt to any existing or future power supply system.

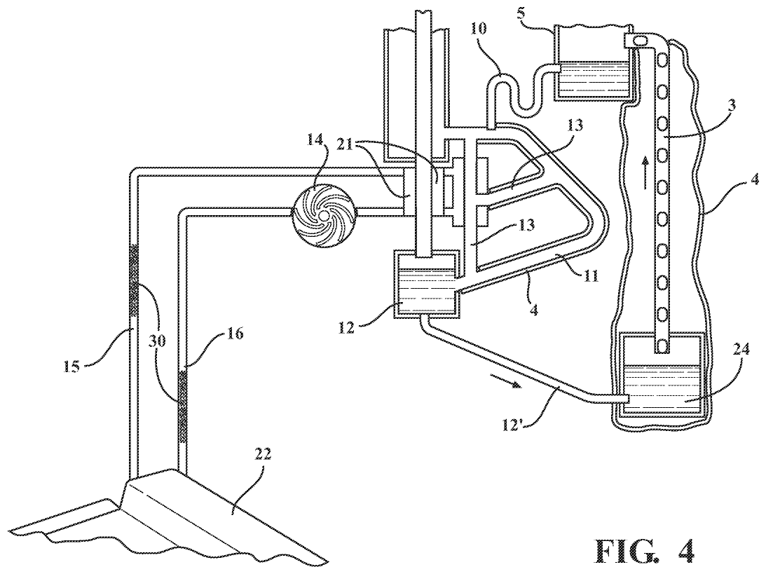

Finally, and as is described in FIG. 4, the role of the manifold separator 13 as a trap expedites hydrogen separation from the hydrogen/ammonia gases mixture 27 to start early absorbing of the ammonia by a weak solution 26, which passes through the vent tube 10 up to the configuration of the robust solution of ionic aqua-ammonia 29 without heat loss, thereby resulting in lower energy consumption.

As further described, a glycol 30 (see also again FIG. 2) communicates to and from the EV battery 22 via the inlet 15 and outlet 16 lines and is used to heat or cool the battery pack, this again as a result of a heat exchange operation with a portion of hydrogen's returning line to the evaporator and the manifold separator 13 by a double heat exchanger equipped, this further assisted by a control valve and temperature sensor to optimize the temperature of battery cells. The glycol solution 30 is contained within the pair of inlet 15 and outlet 16 tubes extending from the battery 22 for heating or cooling the battery as a result of the exchange operation, with a portion of a hydrogen return line to said evaporator 8 and said manifold separator 13 by said double heat exchanger 21 equipped with a control valve and a temperature sensor (not shown).

The design of the ventilation system maintains a constant flow of fresh air withdrawn from the outside and filtered through air drainage inlets/outlets 20, which are parts of the subsystem's space, see at 31 in FIG. 2 and again corresponding to the passenger or cabin interior.

Furthermore, the interior atmosphere inside the cabin is maintained by a control valve 23 (see FIGS. 1a/1b), this to prevent mixing hot and cold air during operation. Likewise, fresh air is withdrawn from the space of the subsystem after being filtered by the blowers 17/18, depending on whether a process for cooling or heating to ventilation inlets 19 of the vehicle interior.

Operationally, heating and cooling are carried out by the HVAC system on the principle of using heat to create cold and expelling heat in the air nearby, which can remove the heat inside as a reversible process, as opposed to heating the surrounding air.

Having described the invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A system for minimizing battery drain loss resulting from environmental temperatures outside of an optimal operating range of an EV battery, comprising:
an HVAC assembly including inputs for heating and cooling a passenger cabin of a vehicle and having a higher voltage drivetrain battery utilizing an induction heat created through an enhanced double-effect absorption process; and
a lower voltage auxiliary battery supplying said HVAC assembly to limit draining of electrical power from the higher voltage battery;
the HVAC assembly heating and cooling at least one of the passenger cabin and the higher voltage drivetrain battery from the enhanced double-effect absorption process using induction energy from the lower voltage auxiliary battery.

2. The system of claim 1, further comprising an input from said HVAC assembly for providing auxiliary heating/cooling of a vehicle passenger compartment to further ameliorate power loss of the higher voltage drivetrain battery.

3. The system of claim 1, further comprising said HVAC assembly utilizing a mixture of hydrogen and ammonia with ionic water as a cooling agent.

4. The system of claim 3, said fluid mixture in said HVAC assembly further comprising a heat generator containing a solution of blended aluminum oxide nanoparticles with distilled water in a range of 0.1-50% by volume.

5. The system of claim 4, said aluminum oxide nanoparticles further comprising carbon nanotubes along with Graphene derivatives.

6. The system of claim 5, said Graphene derivatives further comprising any of a Graphene, monolayer Graphene, few layered Graphene, Graphene oxide, reduced Graphene oxide, and functionalized Graphene.

7. The system of claim 4, said fluid mixture further comprising a refrigerant along with the addition of any of ejectors or pumps.

8. The system of claim 7, said refrigerant further comprising any of R134a-DMAC, R1234(yf & ze)-DMAC, R152a-DMAC, R600-DMAC, R124-DMAC, R744, and LiBr—H₂O.

9. The system of claim 4, further comprising an induction device which generates a magnetic field around said heat generator.

10. The system of claim 4, further comprising a bubble pump within said heat generator enclosed within a thermal insulation.

11. The system of claim 10, further comprising said solution communicating from said bubble pump in succession to each of a rectifier, a condenser, a throttle valve, an evaporator, a heat exchanger, a vent tube, an absorber, a tank with a feedback line, and a manifold separator.

12. The system of claim 11, further comprising a pair of inlet and outlet tubes extending from the battery to a double heat exchanger interposed between said heat exchanger and said tank, a solution pump located in at least said outlet tube.

13. The system of claim 11, further comprising said heat exchanger and evaporator in communication with a passenger compartment of the vehicle, an associated ventilation system of the compartment equipped with blowers in proximity to each of a ventilation inlet and at least one air drainage inlet/outlet, and which are controlled by a valve to drain air within the vehicle or withdraw from it.

14. The system of claim 11, further comprising said ionic aqua-ammonia solution being heated in said heat generator until boiling to create an ammonia water vapor mixture, which is separated in said rectifier into a light ammonia vapour and an aqua-ammonia solution as a weak solution, the ammonia vapour passing through said condenser creating a strong solution of the aqua-ammonia with increased cooling capacity, which is sent to said throttle valve and combined with Hydrogen gas to speed up evaporation and enhance thermal exchange.

15. The system of claim 11, further comprising increased cooling capacity resulting from the hydrogen and ammonia vapor rising from said absorber and passing through both said heat exchanger and double heat exchanger.

16. The system of claim 11, further comprising said solution of blended aluminum oxide nanoparticles being heated using a low voltage from said induction device and, following boil off, passing through said bubble pump and entering said rectifier.

17. The system of claim 11, further comprising separation of the ammonia vapor within said rectifier results in a light ammonia vapour communicating with said condenser and a weak solution aqua-ammonia communicating with said vent tube.

18. The system of claim 12, further comprising said condenser condensing the ammonia vapour, releasing heat to the surrounding air, which can be withdrawn by one of said blowers outside the system or into the cabin, and a hot weak solution of aqua-ammonia recirculates to said absorber via said vent tube), the light ammonia vapour rising from said condenser and returning to a liquid, then expands through said throttle valve to drain into said evaporator.

19. The system of claim 9, further comprising said induction device applying an electromagnetic induction around said heat generator which is constructed of a low-carbon steel, in order to increase a heat applied to said body via a magnetocaloric effect, and then conducting the heat to the ionic aqua-ammonia solution.

20. The system of claim 11, further comprising said manifold separator expediting hydrogen separation from the hydrogen/ammonia gases mixture to begin early ammonia absorption by a weak solution.

21. The system of claim 1, said lower voltage auxiliary battery further comprising a 12V to a 48V source.

22. The system of claim 12, further comprising a glycol solution contained within said pair of inlet and outlet tubes extending from the higher voltage battery for heating or cooling the higher voltage battery, a portion of the hydrogen return line to the evaporator being equipped with a control valve and a temperature sensor for maintaining a battery temperature range.

23. The system of claim 22, said HVAC assembly further comprising a ventilation subsystem to withdraw fresh air from the outside and, following filtering through said air drainage inlets and outlets, said control valve maintaining an interior atmosphere of the vehicle passenger compartment by mixing hot and cold air.

24. The system of claim 10, said bubble pump further comprising internal bumps to intercept and partially capture liquid droplets from the refrigerant vapor.
